(19) United States
(12) Patent Application Publication
(10) Pub. No.: US 2025/0273092 A1
(43) Pub. Date: Aug. 28, 2025

(54) ANTHROPOMORPHIC BREATHING SIMULATORS

(71) Applicant: Magna Electronics, LLC, Southfield, MI (US)

(72) Inventors: Kim Truong, Westford, MA (US); Robert J. Sletten, Bow, NH (US)

(21) Appl. No.: 19/052,109

(22) Filed: Feb. 12, 2025

Related U.S. Application Data
(60) Provisional application No. 63/557,462, filed on Feb. 23, 2024.

(51) Int. Cl. G09B 23/32

(52) U.S. Cl. CPC G09B 23/32

(57) ABSTRACT

Methods, apparatus, and systems for testing breathing rates using an anthropomorphic breathing simulator. In some embodiments, an anthropomorphic breathing simulator may comprise a mechanical breathing assembly positioned within an anthropomorphic body. The mechanical breathing assembly may comprise one or more breathing plates coupled with a rotatable cam plate. Each of the breathing plates may in some cases be coupled with the cam plate by way of a series of curved slots formed in the cam plate such that, upon rotation of the cam plate in one direction, the breathing plates move in a corresponding direction to simulate a first phase of a breathing cycle and, upon rotation of the cam plate in the opposite direction, the breathing plates move in another direction to simulate a second phase of the breathing cycle.

### CROSS-REFERENCE TO RELATED APPLICATIONS

This application claims the benefit of U.S. Provisional Patent Application No. 63/557,462, filed Feb. 23, 2024, and titled “ANTHROPOMORPHIC BREATHING SIMULATORS,” which is hereby incorporated herein by reference in its entirety.

### SUMMARY

RADAR is often used to detect objects exterior to a vehicle, such as other vehicles, pedestrians, and obstacles. Although RADAR, or other electromagnetic signals, are not typically directed inward toward occupants of the cabin, there have been recent trends towards using such signals for internal occupant monitoring, such as for monitoring child presence detection (CPD) and breathing rates of the occupants.

Although such systems have been recently proposed, they may rely upon and/or benefit from testing to ensure that breathing rates can be accurately detected, including preferably for different occupant sizes, ages, and/or positions. However, current anthropomorphic test devices or “test dummies” suffer from various drawbacks. For example, most such devices are configured to evaluate the results of vehicle impacts rather than breathing rates. Breathing dolls are available, but such dolls are not designed for industrial use, let alone long duration breathing rate testing. Such dolls also fail to provide for any control over breathing rates, nor any provision to provide a realistic simulation of the breathing motion and/or human skin, both of which may be important to breathing rate detection using RADAR.

The present inventors have therefore determined that it would be desirable to provide systems and methods that overcome one or more of the foregoing limitations and/or other limitations of the prior art. Apparatus, systems, and methods for testing breathing rates using an anthropomorphic breathing simulator are therefore disclosed herein. Doing so may be used to improve upon in-cabin RADAR monitoring of occupants, which may include, for example, child presence detection, breathing rate monitoring to identify approximate occupant age for occupant classification, health conditions or other safety and/or state conditions, such as sleeping states, and the like.

In some embodiments, the inventive concepts disclosed herein may be used to provide an anthropomorphic test device that simulates human breathing.

In a more particular example of an anthropomorphic breathing simulator, the simulator may comprise a mechanical breathing assembly positioned within an anthropomorphic body. The mechanical breathing assembly may comprise one or more movable plates configured to simulate a breathing motion, which are hereinafter referred to as “breathing plates.” In some embodiments, the mechanical breathing assembly may comprise three breathing plates. The breathing plate(s) may be coupled with a rotatable cam plate that may be configured to be driven to rotate with an electric motor. Each of the breathing plates may be coupled with the cam plate by way of a series of curved slots formed in the cam plate such that, upon rotation of the cam plate in one direction, each of the breathing plates moves in a corresponding direction to simulate a first phase of a breathing cycle. Similarly, upon rotation of the cam plate in the opposite direction, each of the breathing plates may be configured to move in a corresponding opposite direction (relative to the direction of movement of the breathing plates in the first phase) to simulate a second phase of a breathing cycle.

In some embodiments, the breathing may be user adjustable, such as by allowing for adjustment of breathing rates and/or breathing depth.

In some embodiments, one or more of the surfaces of the anthropomorphic body, such as at least any surfaces configured to move during breathing simulation, may be covered with Human Tissue Equivalent Material (HTEM). This HTEM material may be configured to replicate the absorption and/or reflectivity properties of the skin, such as human skin for anthropomorphic embodiments, with respect to RADAR signals.

In some such embodiments, the HTEM may comprise a sealed bag or other sealed, flexible container having an absorptive material saturated with one or more fluids therein. For example, an open-cell foam or another foam may be surrounded by, or in some cases fully saturated with, a fluid, which may comprise a mix of selected chemicals and/or liquids. This foam and fluid composition may then be sealed in a package, such as a sealed plastic bag or other suitable, sealed, flexible container and applied to one or more of the desired surfaces of the anthropomorphic body.

In some methods according to certain implementations, the method may comprise transmitting RADAR signals towards, and processing reflecting signals from, an anthropomorphic breathing simulator. In some such implementations, the method may comprise adjusting the breathing rate and/or breathing depth of the anthropomorphic breathing simulator to calibrate, tune, and/or train a RADAR processing system to allow for detection of breathing rates in human occupants of a vehicle.

In a more particular example of an anthropomorphic breathing simulator according to some embodiments, the breathing simulator may comprise an anthropomorphic body. Aa mechanical breathing simulator assembly may be incorporated within the anthropomorphic body. The mechanical breathing assembly simulator may comprise a plurality of breathing plates. In some embodiments, each of at least two breathing plates of the plurality of breathing plates may be configured to simulate a breathing motion in different directions and/or dimensions, such as along up/down or anterior/posterior directions relative to the body and side-to-side or lateral/medial directions relative to the body. The simulator may further comprise a motor configured to move the breathing plates to simulate multiple phases of a breathing cycle associated with the breathing motion in multiple directions and/or dimensions. In some cases, the motor may be configured to alternate movement of each of the plurality of breathing plates, such as alternating movement of the plates in one or more cycles. In some cases, the motor may be configured to rotate a cam, such as rotating a cam in alternating directions back and forth or, alternatively, continuously rotate the cam so as to result in the plates moving up and down and/or back and forth in one or more cycles.

In some embodiments, the plurality of breathing plates may be configured to simulate a breathing motion along a first direction and along a second direction. The second direction may be angled relative to the first direction. For example, in some cases, the second direction may be at least substantially perpendicular to the first direction, such as one being aligned, or at least substantially aligned, with a posterior/anterior dimension and another being aligned, or at least substantially aligned, with a lateral/medial direction.

In some embodiments, the plurality of breathing plates may comprise a front chest plate configured to simulate breathing within a chest region of the anthropomorphic body along anterior and posterior directions; a first side chest plate configured to simulate breathing within the chest region along lateral and medial directions of a first side of the chest region; and a second side chest plate configured to simulate breathing within the chest region along lateral and medial directions of a second side of the chest region, wherein the second side is positioned opposite from the first side.

Some embodiments may further comprise a rotatable cam plate coupled with the motor. In some such embodiments, the rotatable cam plate may be further coupled with the plurality of breathing plates so as to transfer force from the motor to simulate the breathing motion in different directions. In some such cases, the rotatable cam plate may be configured to be alternately rotated in opposing directions to move the plurality of breathing plates in corresponding opposing directions to simulate breathing. Alternatively, a cam, shaft, and/or cam plate may be configured to rotate in a single direction continuously, which may then result in one or more breathing plates moving back and forth in opposing directions to simulate breathing.

In some embodiments, a breathing rate and/or breathing depth of the anthropomorphic breathing simulator is user adjustable. For example, the speed of the motor may be adjustable to allow for the breathing rate to be precisely selected as desired. Similarly, in cases in which a rotatable cam is provided, for example, the degree of rotation of the cam plate may be adjusted to allow for the breathing depth to be precisely selected.

Some embodiments may further comprise a Human Tissue Equivalent Material configured to replicate reflectivity properties of human skin with respect to RADAR signals. In some such embodiments, the Human Tissue Equivalent Material may be positioned on at least a portion of each exterior moving piece of the breathing assembly, such as each breathing plate of the plurality of breathing plates. In some cases, the Human Tissue Equivalent Material may comprise an absorptive material saturated with one or more fluids sealed within a container.

In another more specific example of a breathing simulator according to some embodiments, the breathing simulator may comprise a mechanical breathing simulation assembly and a motor configured to expand and contract the mechanical breathing simulation assembly to simulate a breathing cycle. In some embodiments, one or more aspects of the simulated breathing motion of the mechanical breathing simulation assembly may user adjustable. In some embodiments, the simulated breathing cycle may provide for movement in multiple directions and/or dimensions rather than simple up and down motion, which may provide for a more realistic breathing simulation.

In some embodiments, the simulated breathing motion of the mechanical breathing simulation assembly may be user adjustable by being configured for user adjustment of a simulated breathing rate of the mechanical breathing simulation assembly. In some embodiments, the simulated breathing motion of the mechanical breathing simulation assembly may alternatively, or additionally, be user adjustable by being configured for user adjustment of a depth of the simulated breathing motion.

In some embodiments, the breathing simulator may comprise an anthropomorphic breathing simulator comprising an anthropomorphic body. Such anthropomorphic body may, at least in part, define a chest region that may be configured to expand and contract to simulate the breathing cycle.

In some embodiments, the motor may be configured to expand and contract the mechanical breathing simulation assembly along multiple cycle directions. In some such embodiments, the multiple cycle directions may comprise an anterior-posterior direction and a lateral-medial direction relative to a body or portion of the breathing simulator configured to approximate or otherwise be used as a body.

In some embodiments, the mechanical breathing simulation assembly may comprise a plurality of breathing plates. In some such embodiments, each of the plurality of breathing plates may be configured to be moved back and forth in opposing directions to simulate the breathing cycle.

In some embodiments, the plurality of breathing plates may comprise a front chest plate configured to simulate breathing within the mechanical breathing simulation assembly along anterior and posterior directions; a first side chest plate configured to simulate breathing within the mechanical breathing simulation assembly along lateral and medial directions of a first lateral side of the mechanical breathing simulation assembly; and a second side chest plate configured to simulate breathing within the mechanical breathing simulation assembly along lateral and medial directions of a second lateral side of the mechanical breathing simulation assembly, wherein the second lateral side is positioned opposite from the first lateral side.

In some embodiments, the mechanical breathing simulation assembly may further comprise a rotatable cam plate coupled with the motor. The rotatable cam plate may be coupled with the plurality of breathing plates so as to transfer force from the motor to simulate the breathing cycle in different dimensions.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1 depicts an anthropomorphic breathing simulator according to some embodiments;

FIG. 2 is a perspective view of a mechanical breathing motor assembly for use in connection with an anthropomorphic breathing simulator according to some embodiments;

FIG. 3 is another perspective view of the mechanical breathing motor assembly of FIG. 2;

FIG. 4 is another perspective view of the mechanical breathing motor assembly of FIGS. 2 and 3;

FIG. 5A depicts the mechanical breathing motor in a fully retracted or fully compressed configuration corresponding with the terminal end of an outbreath portion of a breathing cycle; and

FIG. 5B depicts the mechanical breathing motor in a fully extended configuration corresponding with the terminal end of an inbreath portion of a breathing cycle.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure but is merely representative of possible embodiments of the disclosure. In some cases, well-known structures, materials, or operations are not shown or described in detail.

As used herein, the term “substantially” refers to the complete or nearly complete extent or degree of an action, characteristic, property, state, structure, item, or result to function as indicated. For example, an object that is “substantially” cylindrical or “substantially” perpendicular would mean that the object/feature is either cylindrical/perpendicular or nearly cylindrical/perpendicular so as to result in the same or nearly the same function. The exact allowable degree of deviation provided by this term may depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

Similarly, as used herein, the term “about” is used to provide flexibility to a numerical range endpoint by providing that a given value may be “a little above” or “a little below” the endpoint while still accomplishing the function associated with the range.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

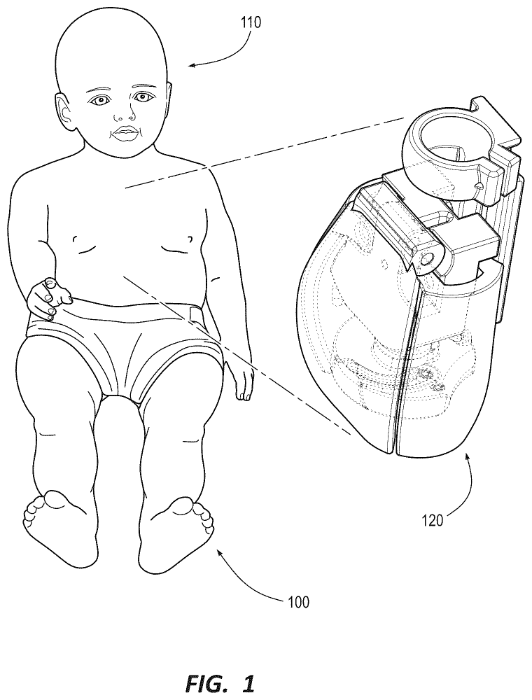

FIG. 1 depicts an anthropomorphic breathing simulator 100 according to some embodiments. As shown in this figure, the breathing simulator 100 comprises an anthropomorphic body 110, which is in the form of an infant in the depicted embodiment, but it is contemplated that various embodiments may be in a variety of other sizes, including newborn babies, toddlers, children, teenagers, adults, and further including various body shapes, sizes, and anatomical features as desired. In one particular example of a selection of available sizes for children, a newborn size may be less than about 0.5 meters in height, an infant size may be between about 0.5 and 0.6 m in height, and a toddler size may be about 0.7 m in height.

It should also be understood that the principles disclosed herein may be used in connection with other animals, some of which may also be detected using in-cabin RADAR signals and therefore may benefit from testing/calibration using the testing apparatus, systems, and methods disclosed herein. For example, it is contemplated that some test devices may be used in the form of pets, such as dogs, cats, and the like.

To facilitate testing by RADAR or other electromagnetic sensors and/or signals within a vehicle, the anthropomorphic body 110 may include one or more surfaces formed with Human Tissue Equivalent Material (HTEM). For example, although the body 110 in FIG. 1 is shown with clothing, in some embodiments, the torso of the body, or in some cases only the chest area, may be formed with HTEM material, which may form and/or be applied to one or more surfaces of the body 110 to simulate human tissue to improve the results of the sensor testing. For embodiments that are used for breathing testing, it may be preferred to apply the HTEM material to all surfaces of the body 110 that are to be moved during the breathing simulation, as discussed below.

In preferred embodiments, the HTEM may be formed by using an absorptive material, such as an open-cell foam or another foam that may be surrounded by, or in some cases fully saturated with, a fluid, which may comprise a mix of selected chemicals and/or liquids. This foam and fluid composition may then be sealed in a package, such as a sealed plastic bag or other suitable, sealed, flexible container and applied to any or all of the aforementioned body surfaces/regions.

Some embodiments may be stuffed and/or otherwise weighted to provide a natural feel and/or a weight that is similar to a human of the same size. This may be accomplished using, in part, the HTEM, but may also require other materials.

A mechanical breathing motor assembly 120 is installed within the body 110—preferably below the HTEM layer(s) when such materials are incorporated into the body 110—within the torso and/or chest region of the body 110. As described in greater detail below, motor assembly 120 may be configured to expand and contract the chest of the body 110 to simulate human breathing patterns. This may allow the anthropomorphic breathing simulator 100 to be used to design, test, and/or calibrate RADAR or other in-cabin vehicle sensors for detecting breathing rates and/or patterns of human vehicle occupants, such as in-cabin vehicle sensors configured to use patterns, such as repetition frequency patterns in RADAR, Doppler spectrum signals, to estimate breathing rates. Such breathing rates may then be used to infer various conditions about vehicle occupants, such as concerning health conditions, sleeping conditions, occupant ages, etc.

For example, once a breathing rate has been estimated for one or more occupants with a vehicle using RADAR or other electromagnetic signal processing, this data may be used to classify the occupant(s). Because respiratory rates are strongly correlated with age, an estimate of the age of the occupant may be made using the estimated breathing rate derived from the RADAR signal processing. Thus, testing in-cabin RADAR sensors to ensure the accuracy of breathing rate detection for a variety of occupant ages, sizes, and/or positions may be valuable.

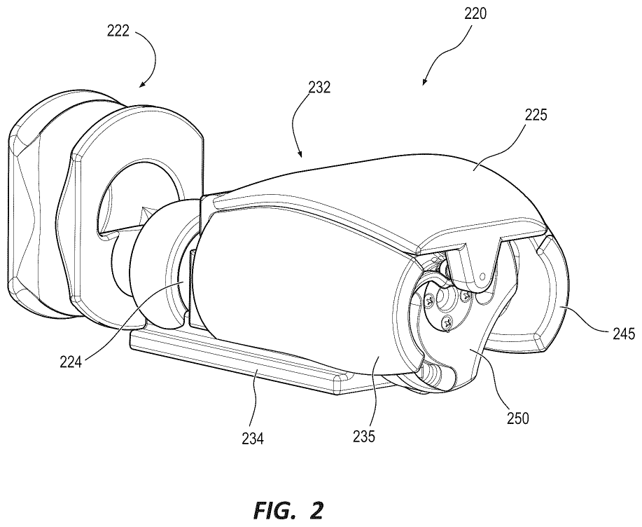

A more detailed example of a mechanical breathing motor assembly 220 is shown in FIG. 2. As shown in this figure, breathing motor assembly 220 may comprise a head base 222, which may be coupled with a swivel ball joint 224 to allow the head of the corresponding body to be rotated and/or pivoted, which may allow for positioning of the resulting anthropomorphic body in a variety of different positions for testing. A more life-like, anthropomorphic head, such as the head depicted in FIG. 1, may be installed over the head base 222 if desired.

Mechanical breathing motor assembly 220 further comprises torso base 232, which may comprise a plurality of moving surfaces or “breathing plates.” More particularly, the depicted motor assembly 220 comprises a front chest plate 225 and two opposing side chest plates 235 and 245. As described in greater detail below, each of these three breathing plates is configured to move in a different direction and/or dimension, thereby allowing the resulting doll or test device to simulate human breathing in three different directions/dimensions and/or along two different axes, which provides a more realistic simulation of human breathing patterns.

Each of the three breathing plates 225/235/245 may be operated by a single motor operably coupled with a single, rotatable or cam plate 250. The motor may be hard-wired for external power, in some cases via USB (5V). Other embodiments may be battery powered.

As discussed in greater detail below in connection with other figures, cam plate 250 comprises a plurality of curved slots, each of which receives a shaft coupled to a respective one of the breathing plates 225/235/245. In this manner, by turning the cam plate 250 back and forth, each of the breathing plates 225/235/245 may be configured to move back and forth to simulate breathing.

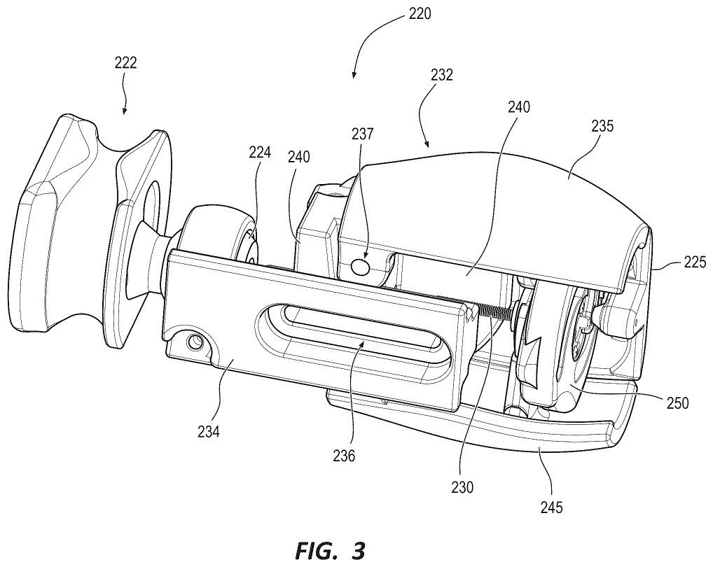

FIG. 3 illustrates the back portion of the breathing motor assembly 220. As shown in this figure, the head base 222 is coupled with the torso base 232 along a neck plate 234 comprising an elongated, straight slot 236. Slot 236 may be slidably coupled with a fastener and/or other protruding member of the torso base 232 to allow the head base 222 to be adjustably positioned relative to the torso base 232. Stated otherwise, the distance between the head base 222 and the torso base 232 may be adjusted by sliding the fastener along the slot 236 and then fixedly securing the desired position by locking the fastener at a particular position along the slot 236. This locking may be accomplished by any means available to those of ordinary skill in the art, such as a nut, locking washer, clamp, or the like.

FIG. 3 also depicts the drive shaft 230 of the breathing motor assembly 220. Drive shaft 230 may be rotated by way of a motor such as, for example, a servo motor. In some embodiments, drive shaft 230 may be threaded, and may drive rotation of the cam plate 250. The cam plate 250 may be coupled to the motor with a plurality of additional screws or other fasteners that may fasten to a servo horn to apply the rotational force for additional robustness.

Of course, a wide variety of alternatives would be apparent to those of ordinary skill in the art. For example, in some embodiments, snap-on fasteners or magnetic couplers may be used. In still other embodiments, other means for applying a rotational force may be used, such as pneumatic actuators, hydraulic actuators, solenoids, spring mechanisms, or a mechanical linkage, such as one involving gears, belts, chains, or the like. Similarly, knurled, keyed, or splined shafts may be used to impart rotational motion in some embodiments.

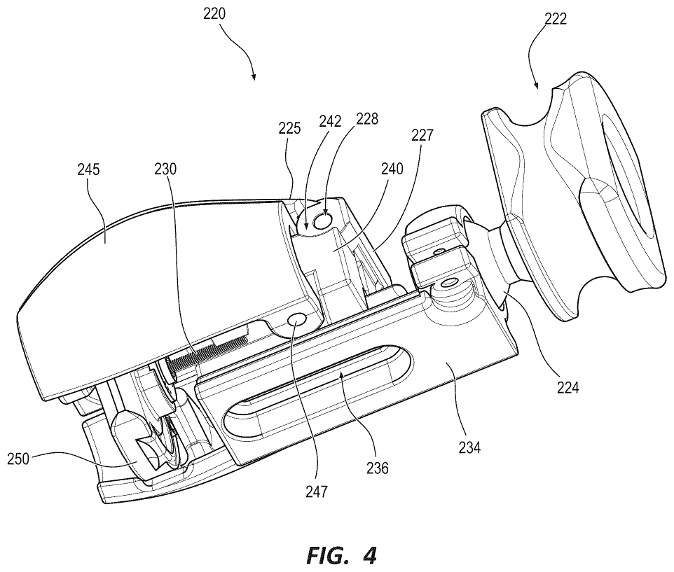

Joints, which may include roller bearings, may be formed at various locations forming connections between moving parts in breathing motor assembly 220. For example, as shown in FIG. 3, a pivot joint 237 may be formed to couple side breathing plate 235 with the frame 240 of the breathing motor assembly 220. A similar joint (not shown in FIG. 3; see FIG. 4) may be formed to couple side breathing plate 245 with frame 240.

As best seen in FIG. 4, an elongated groove 242 may be formed in frame 240, which groove 242 may receive a corresponding, elongated sleeve 227 coupled with front breathing plate 225. Sleeve 227 is pivotably and/or rotatably coupled with groove 242 to allow the opposite side of plate 225 to be moved up and down by a suitable motor, as mentioned above. A bore hole 228 is formed in sleeve 227, which is configured to receive a bolt or other fastener that extends through a corresponding hole formed in a portion of frame 240 to pivotably and/or rotatably couple the plate 225 to the frame 240. FIG. 4 also depicts another pivot joint 247 that, similar to pivot joint 237 referenced above in connection with FIG. 3, pivotably and/or rotatably couples side plate 245 to frame 240.

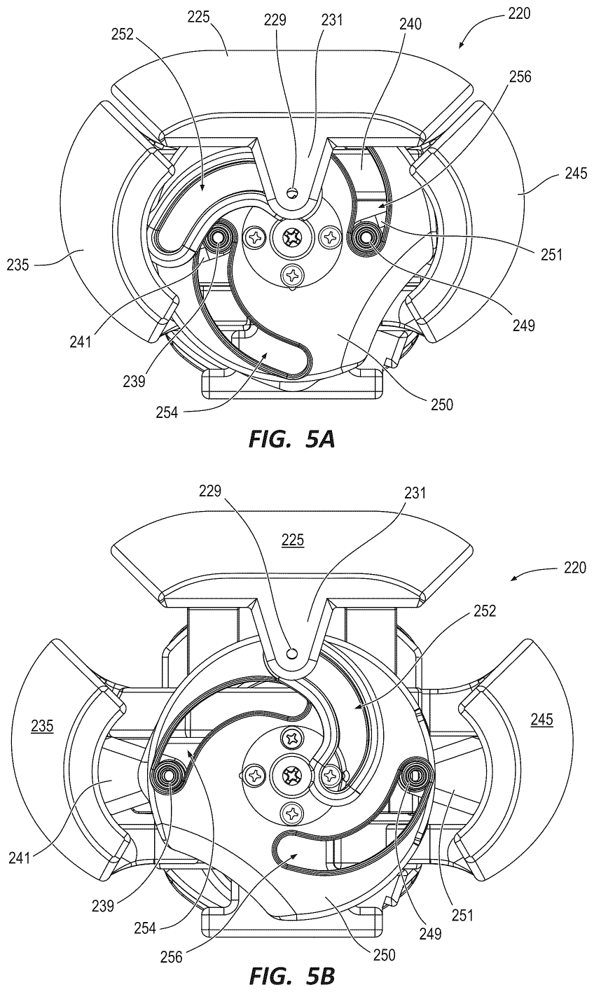

FIGS. 5A and 5B depict the breathing motor assembly 220 in fully retracted and fully extended configurations, respectively. As shown in the retracted configuration of FIG. 5A, the three breathing plates 225/235/245 are all in a position in which they are most closely retracted towards the center or core of the frame 240 and assembly 220.

FIG. 5A further illustrates each of the slot coupling members used to couple a respective breathing plate with a respective curved slot on cam plate 250. More particularly, coupling member 229 is inserted within slot 252, coupling member 239 is inserted within slot 254, and coupling member 249 is inserted within slot 256. By rotating cam plate 250, each of the coupling members 229/239/249 may move within its respective curved slot 252/254/256, thereby moving the respective breathing plate 225/235/245 coupled thereto. In some embodiments, the slots 252/254/256 may be configured to provide a sinusoidal, or at least substantially sinusoidal, movement.

Thus, as shown in FIG. 5B, after rotating cam plate 250 in a clockwise direction, breathing plates 225/235/245 are all in a position in which they are most fully extended away from the center or core of the frame 240 and assembly 220. In addition, whereas each of the coupling members 229/239/249 is positioned at one terminal end within its respective curved slot 252/254/256 in FIG. 5A, each of the coupling members 229/239/249 is positioned at the opposite terminal end of its respective curved slot 252/254/256 in FIG. 5B, indicating that no further movement in this direction can be made. After reaching this position, the motor may be configured to rotate the cam plate 250 in the opposite direction-i.e., in a counterclockwise direction-to simulate the outbreath phase of a breathing cycle.

FIGS. 5A and 5B therefore illustrate the maximal extent or depth of breathing motion. However, it should be understood that, at least in preferred embodiments, the “depth” of the breathing simulation may be adjustable by a user. In other words, in the depicted embodiment, the motor may be configured to be selectively adjusted, such as via a suitable user interface, to only partially rotate the cam plate 250 such that each of the respective coupling members 229/239/249 goes from the terminal end of its respective slot-as shown in FIG. 5A-to a midpoint between the opposite terminal ends, rather than to the terminal ends shown in FIG. 5B, during the inbreath phase of the breathing cycle.

FIG. 5B also best illustrates the presence of coupling arms extending from each of the respective breathing plates 225/235/245. Coupling arm 231 extends between and couples breathing plate 225 with slot coupling member 229, coupling arm 241 extends between and couples breathing plate 235 with slot coupling member 239, and coupling arm 251 extends between and couples breathing plate 245 with slot coupling member 249.

The extent of this depth adjustment may be within a discrete number of locations/sizes in some embodiments. In other words, a user may be able to select, for example, shallow, medium, or deep breaths. Alternatively, a user may be able to select an effectively, or at least substantially, infinite number of adjustment positions using a dial or the like to finely tune the breathing depth within the available positions defined by the length of the curved slots 252/254/256, if desired.

Similarly, in preferred embodiments, the breathing rate may also, or alternatively, be adjustable. For example, a user may be able to select a specific breathing rate in breaths per minute (BPM). In some cases, a user may be able to manually select a BPM between, for example, 10 BPM and 60 BPM. As with the depth adjustment, the adjustment of the BPM rate may be discrete, such as every BPM or 2 BPMs, or may be effectively allow for an infinite number of gradations by way of a dial or the like.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. An anthropomorphic breathing simulator, comprising:
an anthropomorphic body;
a mechanical breathing simulator assembly incorporated within the anthropomorphic body, the mechanical breathing assembly simulator comprising:
a plurality of breathing plates, wherein at least two breathing plates of the plurality of breathing plates are configured to simulate a breathing motion in different directions; and
a motor configured to move of each of the plurality of breathing plates to simulate multiple phases of a breathing cycle associated with the breathing motion in multiple dimensions.

2. The anthropomorphic breathing simulator of claim 1, wherein the plurality of breathing plates is configured to simulate a breathing motion along a first direction and along a second direction, the second direction being at least substantially perpendicular to the first direction.

3. The anthropomorphic breathing simulator of claim 2, wherein the first direction comprises an anterior direction, and wherein the second direction comprises a lateral direction.

4. The anthropomorphic breathing simulator of claim 2, wherein the plurality of breathing plates comprises:
a front chest plate configured to simulate breathing within a chest region of the anthropomorphic body along anterior and posterior directions;
a first side chest plate configured to simulate breathing within the chest region along lateral and medial directions of a first side of the chest region; and
a second side chest plate configured to simulate breathing within the chest region along lateral and medial directions of a second side of the chest region, wherein the second side is positioned opposite from the first side.

5. The anthropomorphic breathing simulator of claim 1, further comprising a rotatable cam plate coupled with the motor, wherein the rotatable cam plate is further coupled with the plurality of breathing plates so as to transfer force from the motor to simulate the breathing motion in different directions.

6. The anthropomorphic breathing simulator of claim 5, wherein the rotatable cam plate is configured to be rotated in opposing directions to move the plurality of breathing plates in corresponding opposing directions to simulate breathing.

7. The anthropomorphic breathing simulator of claim 1, wherein the anthropomorphic body is in the form of a human infant.

8. The anthropomorphic breathing simulator of claim 1, wherein a breathing rate of the anthropomorphic breathing simulator is user adjustable.

9. The anthropomorphic breathing simulator of claim 1, further comprising a Human Tissue Equivalent Material configured to replicate reflectivity properties of human skin with respect to RADAR signals.

10. The anthropomorphic breathing simulator of claim 9, wherein the Human Tissue Equivalent Material is positioned on at least a portion of each breathing plate of the plurality of breathing plates.

11. The anthropomorphic breathing simulator of claim 9, wherein the Human Tissue Equivalent Material comprises an absorptive material saturated with one or more fluids sealed within a container.

12. A breathing simulator, comprising:
a mechanical breathing simulation assembly;
a motor configured to expand and contract the mechanical breathing simulation assembly to simulate a breathing cycle,
wherein a simulated breathing motion of the mechanical breathing simulation assembly is user adjustable.

13. The breathing simulator of claim 12, wherein the simulated breathing motion of the mechanical breathing simulation assembly is user adjustable by being configured for user adjustment of a simulated breathing rate of the mechanical breathing simulation assembly.

14. The breathing simulator of claim 12, wherein the simulated breathing motion of the mechanical breathing simulation assembly is user adjustable by being configured for user adjustment of a depth of the simulated breathing motion.

15. The breathing simulator of claim 12, wherein the breathing simulator comprises an anthropomorphic breathing simulator comprising an anthropomorphic body forming, at least in part, a chest region, and wherein the chest region is configured to expand and contract to simulate the breathing cycle.

16. The breathing simulator of claim 12, wherein the motor is configured to expand and contract the mechanical breathing simulation assembly along multiple cycle directions.

17. The breathing simulator of claim 16, wherein the multiple cycle directions comprise an anterior-posterior direction and a lateral-medial direction.

18. The breathing simulator of claim 12, wherein the mechanical breathing simulation assembly comprises a plurality of breathing plates, and wherein each of the plurality of breathing plates is configured to be moved back and forth in opposing directions to simulate the breathing cycle.

19. The breathing simulator of claim 18, wherein the plurality of breathing plates comprises:
a front chest plate configured to simulate breathing within the mechanical breathing simulation assembly along anterior and posterior directions;
a first side chest plate configured to simulate breathing within the mechanical breathing simulation assembly along lateral and medial directions of a first lateral side of the mechanical breathing simulation assembly; and
a second side chest plate configured to simulate breathing within the mechanical breathing simulation assembly along lateral and medial directions of a second lateral side of the mechanical breathing simulation assembly, wherein the second lateral side is positioned opposite from the first lateral side.

20. The breathing simulator of claim 18, wherein the mechanical breathing simulation assembly further comprises a rotatable cam plate coupled with the motor, wherein the rotatable cam plate is coupled with the plurality of breathing plates so as to transfer force from the motor to simulate the breathing cycle in different dimensions.
